(19) United States
(12) Patent Application Publication
(10) Pub. No.: US 2012/0121118 A1
(43) Pub. Date: May 17, 2012

(54) SLOTTED WAVEGUIDE FOR LOUDSPEAKERS

(75) Inventors: Anthony Fregoso, Temple City, CA (US); Henry Goldansky, Chula Vista, CA (US)

(73) Assignee: Harman International Industries, Incorporated, Northridge, CA (US)

(21) Appl. No.: 12/948,651

(22) Filed: Nov. 17, 2010

(51) Int. Cl. H04R 1/20

(52) U.S. Cl. 381/337

(57) ABSTRACT

A slotted waveguide for use with an electrodynamic transducer is described. The slotted waveguide has a transducer front surface for radiating acoustic energy from the electrodynamic transducer. The transducer front surface is concave and the electrodynamic transducer is operable to a desired high frequency. The slotted waveguide may include a body and a volume displacement element. The slotted opening has a width not substantially greater than a wavelength corresponding to the desired high frequency and the volume displacement element has a displacement surface that extends inward into the electrodynamic transducer and complements in shape the transducer front surface.

### BACKGROUND OF THE INVENTION

1. Field of the Invention

The present invention relates to the field of loudspeakers, and, more particularly, to loudspeakers that utilize slotted waveguides.

2. Related Art

High fidelity speaker and loudspeaker systems have been known for a long time and attempts to improve the performance of these types of speaker systems has been continuously pursued. As an example, acoustic line arrays have been designed to improve the directivity of many modern speaker systems. It is appreciated by those skilled in the art that acoustic line arrays are loudspeaker systems that have a number of loudspeaker elements coupled together in a line segment to emulate a line source of sound. Generally, the distance between adjacent drivers is close enough that they constructively sum with each other in order to project sound waves in a different manner than traditional horn-loaded loudspeakers, and with an evenly distributed broad horizontal sound dispersion pattern and narrow vertical dispersion pattern.

Acoustic line arrays can be oriented in any direction, but generally they are used in vertical arrays which provide a very narrow vertical output pattern useful for focusing sound pressure at the audience without wasting output energy on ceilings or empty spaces above the listening target area. This property is known as directivity. In particular, horizontal directivity is a measure of amplitude linearity for different frequencies over a horizontal angle in front of the loudspeaker. As an example in a stereo system, the stereo system produces a virtual image for the listener by taking advantage of the localization ability of human hearing. Accordingly, relatively constant horizontal directivity is desired over a fairly wide angle from the vertical axis of the loudspeaker array.

Several attempts have been made in the past to address and improve directivity such as, for example, U.S. patent application Ser. No. 11/249,572, titled “Loudspeaker Including Slotted Waveguide For Enhanced Directivity And Associated Methods,” filed on Oct. 13, 2005 by B. E. Cheney, (the '572 reference) which is herein incorporated by reference in its entirety. Unfortunately, the '572 reference has a number of disadvantages including, for example, a problem with acoustic mass that causes a loss of high frequencies.

As such, there is a need for a speaker system that solves the above mentioned problems.

### SUMMARY

A slotted waveguide for use with an electrodynamic transducer is described. The slotted waveguide has a transducer front surface for radiating acoustic energy from the electrodynamic transducer. The transducer front surface is concave and the electrodynamic transducer is operable to a desired high frequency. The slotted waveguide may include a body and a volume displacement element. The slotted opening has a width not substantially greater than a wavelength corresponding to the desired high frequency and the volume displacement element has a displacement surface that extends inward into the electrodynamic transducer and complements in shape the transducer front surface. Generally, the electrodynamic transducer is a loudspeaker driver and the loudspeaker driver may be a circular (i.e., conical) or elliptical driver.

Also described is a loudspeaker system. The loudspeaker system may include a loudspeaker driver, slotted waveguide, and volume displacement element. The loudspeaker driver has a driver front surface for radiating acoustic energy from the loudspeaker driver, where the driver front surface is concave. The slotted waveguide is adjacent the driver front surface and the volume displacement element is adjacent the driver front surface. The volume displacement element is convex and is attached to the rear side of the slotted waveguide.

An acoustic line array of slotted waveguides (“ALASW”) is also described. The ALASW is for use with a plurality of loudspeaker drivers, where each loudspeaker driver has a loudspeaker driver front surface for radiating acoustic energy from the loudspeaker driver. The loudspeaker driver front surface is concave and is operable to a desired high frequency. The ALASW may include a plurality of body elements and a plurality of volume displacement elements. Each body element includes a slotted opening with a width not substantially greater than a wavelength corresponding to the desired high frequency and each volume displacement element has a displacement surface that extends inward into the loudspeaker driver and complements in shape the loudspeaker driver front surface which corresponds to the volume displacement element.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a front view of an example of an implementation of a slotted waveguide for use with an electrodynamic transducer.

FIG. 2 is a back perspective view of the example of an implementation of the slotted waveguide shown in FIG. 1.

FIG. 3 is a side view of the example of an implementation of the slotted waveguide as shown in FIGS. 1 and 2.

FIG. 4 is a front perspective view of an example of an implementation of an elliptical driver.

FIG. 5 is a top side view of an example of an implementation of a loudspeaker system having a loudspeaker driver and slotted waveguide.

FIG. 6 is a side view of the example of the implementation of a loudspeaker system having the loudspeaker driver and slotted waveguide as shown in FIG. 5.

FIG. 7 is a front perspective view of an example of an implementation of an ALASW.

FIG. 8 is a back perspective view is shown of the example of an implementation of the ALASW shown in FIG. 7.

### DETAILED DESCRIPTION

A slotted waveguide for use with an electrodynamic transducer is described. The electrodynamic transducer has a transducer front surface for radiating acoustic energy from the electrodynamic transducer. The transducer front surface is concave and the electrodynamic transducer is operable to a desired high frequency. The slotted waveguide may include a waveguide body with a slotted opening with a width not substantially greater than a wavelength corresponding to the desired high frequency and a volume displacement element having a displacement surface that extends inward into the electrodynamic transducer and complements in shape the transducer front surface. In general, the electrodynamic transducer is a loudspeaker driver and the loudspeaker driver may be elliptical, circular (i.e., known as conical), rectangular, or racetrack-type in shape.

Additionally, a loudspeaker system is described that may include a loudspeaker driver having a driver front surface for radiating acoustic energy from the loudspeaker driver, where the driver front surface is concave. The loudspeaker system may also includes a slotted waveguide adjacent the driver front surface and a volume displacement element adjacent the driver front surface, where the volume displacement element is convex and is attached to the rear of the slotted waveguide. The loudspeaker driver may be a conical driver, elliptical driver, rectangular, or racetrack-type in shape.

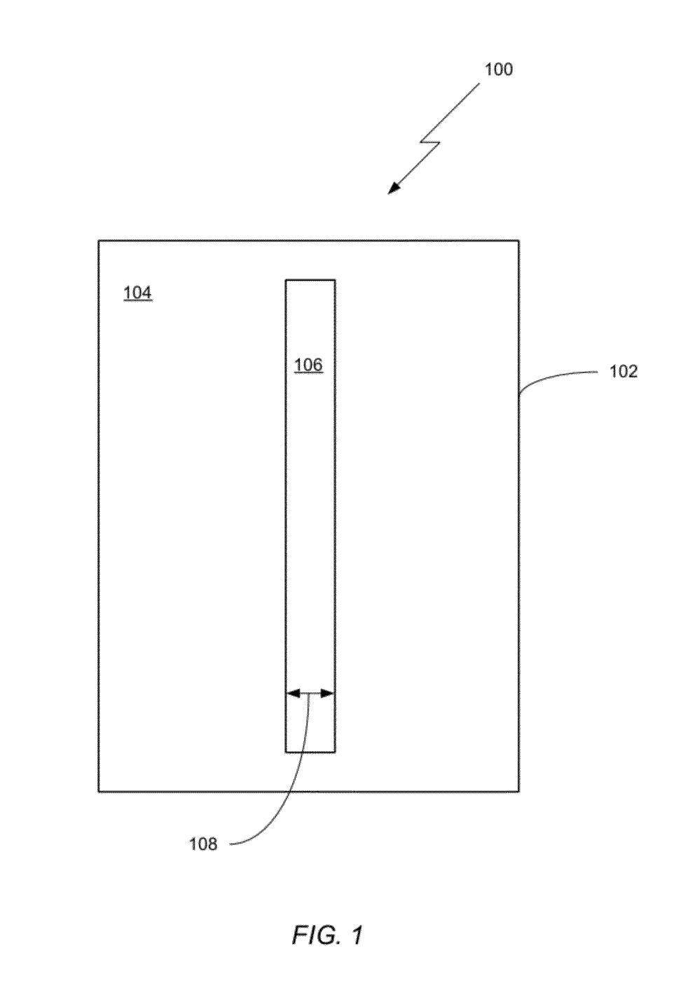

As an example, in FIG. 1, a front view of an example of an implementation of a slotted waveguide 100 for use with an electrodynamic transducer (not shown) is shown. The slotted waveguide 100 may include a waveguide body 102 having a waveguide front face 104 with a slotted opening 106 cut through the waveguide front face 104 and waveguide body 102. The slotted opening has a width 108. The waveguide body 102 is designed to cover the front face (not shown) of the electrodynamic transducer (not shown) such as a loudspeaker driver.

In general, the slotted opening 104 is a diffraction slot that loads the loudspeaker driver and broadens and controls the horizontal coverage of the loudspeaker driver while minimizing frequency response irregularities. The waveguide body 102 may be constructed from, for example, thermoplastic resin, thermoset resin, wood, metal, foamed polymer, etc. Assuming that the loudspeaker driver is operable to a desired high frequency, the width 106 of the slotted opening 104 should not be substantially greater than the wavelength corresponding to the highest desired frequency.

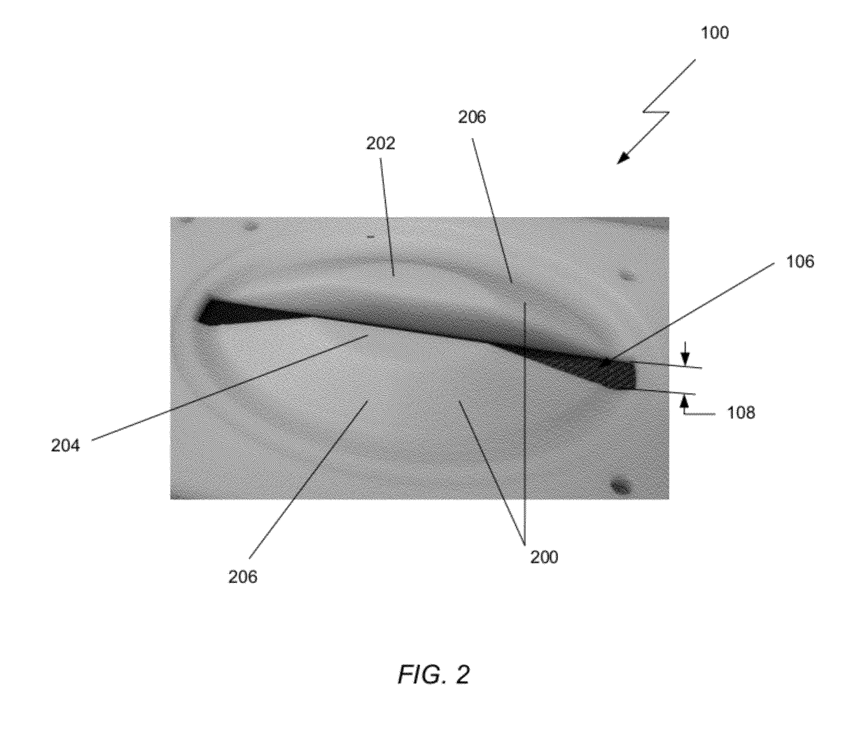

In FIG. 2, a back perspective view is shown of the example of an implementation of the slotted waveguide 100 shown in FIG. 1. The slotted waveguide 100 includes a volume displacement element 200 that is shown as having two halves 202 and 204. The volume displacement element 200 includes a displacement surface 206 that is convex and is designed to extend inwards into loudspeaker driver (not shown) complementing the shape of a driver front surface (not shown) of the loudspeaker driver (not shown).

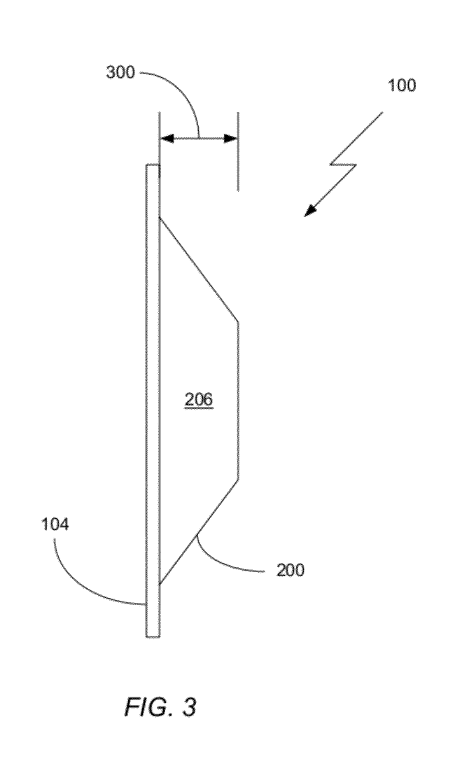

In FIG. 3, a side view is shown of the example of an implementation of the slotted waveguide 100 shown in FIGS. 1 and 2. The displacement surface 206 of the volume displacement element 200 is shown extending a depth 300 that corresponds to the depth of loudspeaker driver (not shown).

As discussed above, in general, the electrodynamic transducer is a loudspeaker driver and the loudspeaker driver may be elliptical, conical in shape, rectangular, or racetrack-type in shape.

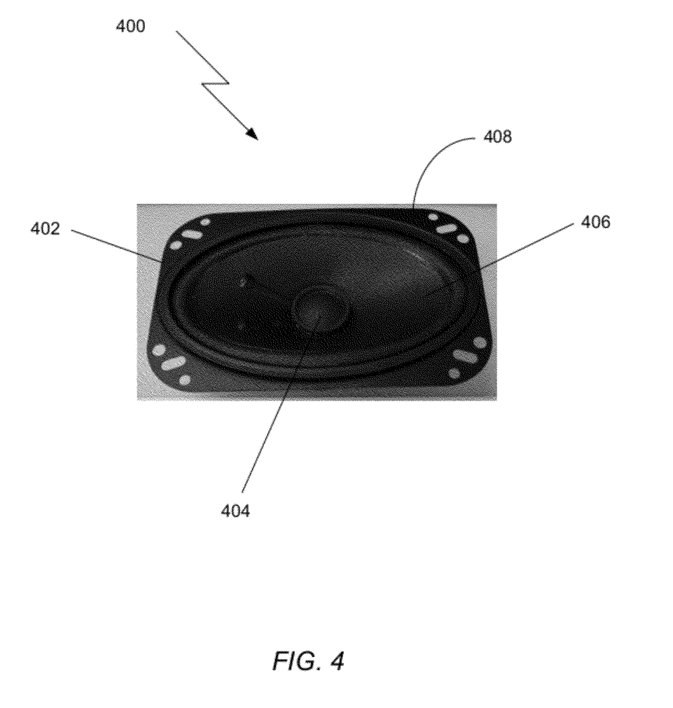

As an example, in FIG. 4, a front perspective view of an example of an implementation of an elliptical driver 400 is shown. The elliptical driver 400 may include a driver housing 402, driver center 404, and a driver front surface 406. The driver front surface 406 is concave in shape and extends from the front 408 of the driver housing 402 to the driver center 404. The shape of elliptical driver 400 is elliptical where by definition the major axis is longer than the minor axis. In general, elliptical drivers, such as elliptical driver 400, are well known to those skilled in the art and are available generically in ratios of four (4) by six (6), six (6) by nine (9), four by ten (10), Five (5) by seven (7), etc.

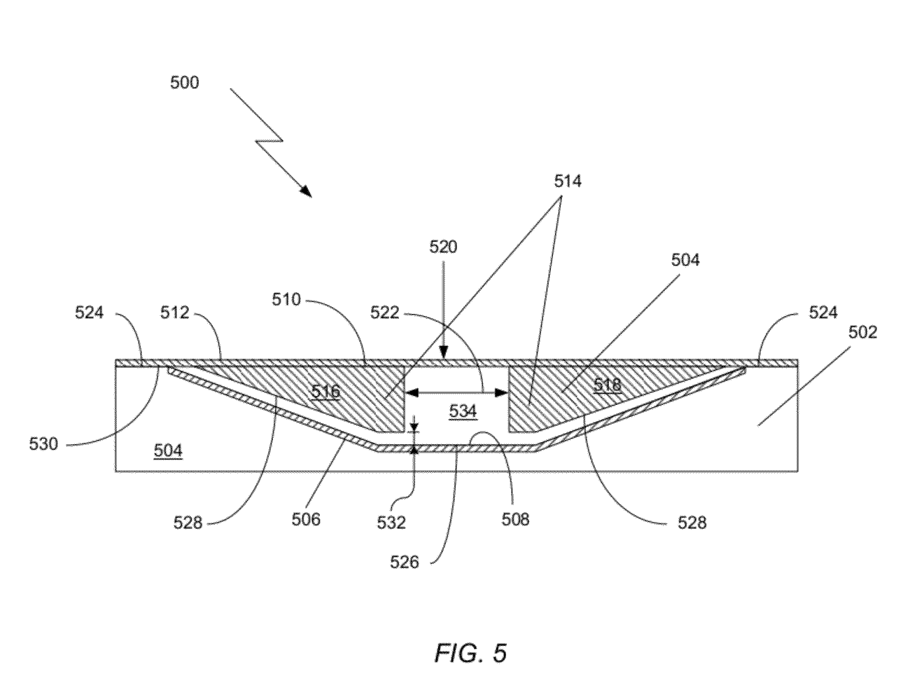

Turning to FIG. 5, in FIG. 5, a top side view is shown of an example of an implementation of a loudspeaker system 500 having a loudspeaker driver (i.e., an electrodynamic transducer) 502 and slotted waveguide 504. In this example, the loudspeaker driver 502 includes a driver housing 504 and driver membrane 506 having a driver front surface (also herein referred to as a “transducer front surface”) 508. The driver membrane 506 is generally known as the “speaker cone.” The slotted waveguide 504 includes a waveguide body 510, having a waveguide front face 512, a volume displacement element 514 (that is shown as having two halves 516 and 518), and a slotted opening (not shown in this view) cut through the waveguide front face 512 at location 520 and having a width 504 equal to the distance between the two halves 516 and 518 of the volume displacement element 514. The waveguide body 510 is designed to cover the front face 524 of the loudspeaker driver 502. The loudspeaker driver 502 and slotted waveguide 504 may be removably attached. Additionally, the loudspeaker driver 502 may be a conical driver or an elliptical driver, rectangular, or racetrack-type in shape.

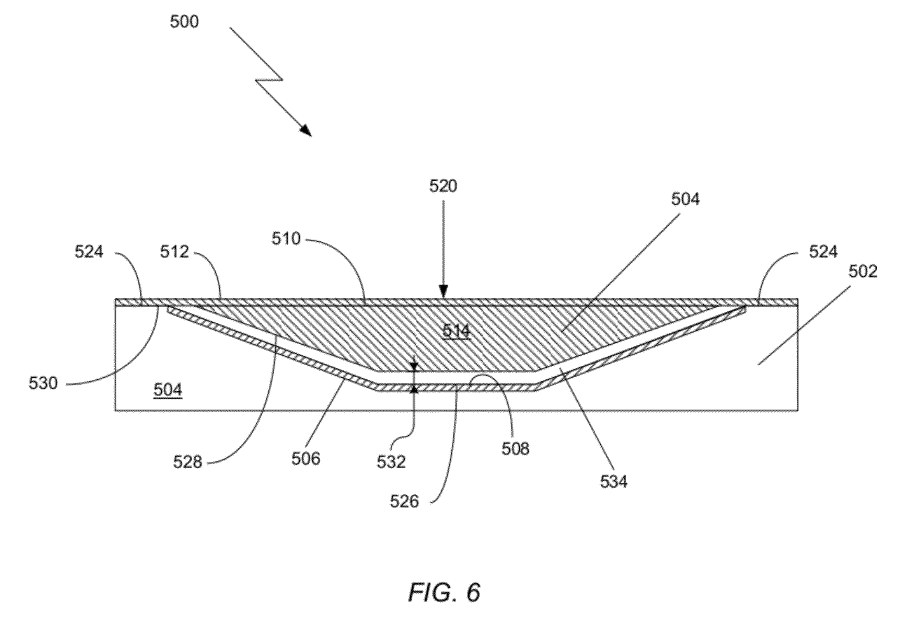

The driver front surface 508 is concave and extends inward into the loudspeaker driver 502 from the loudspeaker front face 524 to the driver center 526 defining an open volume that may be generally referred to as a “cone volume” (also herein referred to as a “transducer volume”) of the loudspeaker driver 502. The volume displacement element 514 has a displacement surface 528 that is convex and extends away from the back side 530 of the waveguide front face 512 into the loudspeaker driver 502. The displacement surface 528 compliments in shape the driver front surface 508. In this example, the displacement surface 528 is shown extending a depth that is approximately equal to the depth of the cone of the loudspeaker driver 502. As an example, the displacement surface 528 may extend into the cone volume of the loudspeaker such that displacement surface 528 is spaced 532 approximately between 0.5 millimeters (“mm”) to 4 mm from the driver front surface 508. This spacing dimension is for high frequency reproduction and will vary according to the particular driver utilized and desired high frequency cutoff point. It is appreciated by those skilled in the art that 8 inch cone driver will move much farther than a 2.5 inch cone driver thereby requiring a greater spacing between the displacement surface 528 and driver front surface 508. In this example, the volume displacement element 514 and driver front surface 508 define an open volume (i.e., an air cavity also herein referred to as an “air cavity volume”) 534 between the volume displacement element 514 and loudspeaker driver 502. The air cavity volume 534 and the corresponding air mass are important for high frequency performance. As a further example, the displacement surface 528 may extend into the cone volume of the loudspeaker such that displacement surface 528 is spaced 532 approximately 2 mm from the driver front surface 508. In FIG. 6, a side view is shown of the example of the implementation of a loudspeaker system 500 having the loudspeaker driver 502 and slotted waveguide 504 shown in FIG. 5.

As an example of operation, loudspeaker system 500 is capable of producing acoustic energy (i.e., sound) that has a broadened and controlled horizontal coverage (i.e., directivity) as compared to the sound that the loudspeaker driver 502 is capable of producing without the slotted waveguide 504. The reason for this is result of both the slotted opening 520 and the volume displacement element 514. The slotted opening 520 acts as diffraction slot that loads the loudspeaker 502 and increases the directivity of sound produced by the loudspeaker 502. However, the slotted opening 520 causes air backpressure on the loudspeaker 502 by trapping air between the slotted opening 520 and loudspeaker 502 because the slotted opening 520 funnels all of the air in the cone of loudspeaker 502 through the slotted opening 520 and, therefore, does not allow all of the air in cone of loudspeaker 502 to freely radiate outward from the loudspeaker 502. Normally, this effect would cause a drop-off of the high end of the frequency response of the loudspeaker system because air has mass and the effect of trapping a large amount of air between the slotted opening and cone of the loudspeaker causes the acoustic mass of the air to increase and, therefore, act as an acoustic filter.

As an example, the cavity resonant frequency of cavity is defined as

$${f}_{resonance} = \frac{v}{2 π} \sqrt{\frac{A}{VL}} ,$$

where f_{resonance} is the resonant frequency, v is the speed of sound, A is the area of the opening of the cavity, V is the volume of the cavity and L is the length of the opening port. If the area of the opening of the cavity is 5 cm², the volume of the cavity is 12 cm³, the length of the opening port is 0.321205 cm, and the speed of sound is 343.7 meters/second, the corresponding resonant frequency will be 6.230 KHz. If the volume of the cavity is doubled to 24 cm3, the resonant frequency (i.e, the “roll-off”) will occur at 4.405 KHz, which is approximately 25% lower than the 6.230 KHz of the smaller volume cavity.

To reduce this filtering effect, the loudspeaker system 500 utilizes the volume displacement element 514 to displace the air volume 534 located between the driver front surface 508 and the slotted waveguide 504. As a result, the volume displacement element 514 increases the resonant frequency of the minimized air space in open volume 534, which reduces the acoustic low pass filter effect of not having the volume displacement element 514. The volume displacement element 514 also reduces the notch caused by air mass resonance. These improvements reduce the number of electronic filters needed to tune the loudspeaker system 500.

It is appreciated by those skilled in the art that there has been an increase in the use of acoustic line arrays and line sources in modern loudspeaker designs. As such, it is appreciated that the above described loudspeaker system 500 may be readily applied to new acoustic line source designs. Specifically, an improved acoustic line array may be created by utilizing a plurality of loudspeaker systems 500.

In this example, an acoustic line array loudspeaker system (“ALALS”) may include a plurality of loudspeaker drivers each having a driver front surface for radiating acoustic energy from each loudspeaker driver, where each driver front surface is concave. The ALALS may also include a plurality of slotted waveguides adjacent to the plurality of loudspeaker drivers and a plurality of volume displacement elements. In this example, each individual slotted waveguide is adjacent to each individual driver front surface, each volume displacement element is adjacent each driver front surface, and each volume displacement element is convex and is attached to each slotted waveguide. Similar to the above description, each loudspeaker driver may be a conical or elliptical, rectangular, or racetrack-type loudspeaker driver.

Additionally, in this example, an acoustic line array of slotted waveguides (“ALASW”) may be utilized with the ALALS. The ALASW is for use with a plurality of loudspeaker drivers. In this example, each loudspeaker driver has a loudspeaker driver front surface for radiating acoustic energy from the loudspeaker driver, the loudspeaker driver front surface is concave, and the loudspeaker driver is operable to a desired high frequency. The ALASW may include a plurality of body elements and a plurality of volume displacement elements. Each body element includes a slotted opening with a width not substantially greater than a wavelength corresponding to the desired high frequency and each volume displacement element has a displacement surface that extends inward into the loudspeaker driver and complements in shape the loudspeaker driver front surface which corresponds to the volume displacement element.

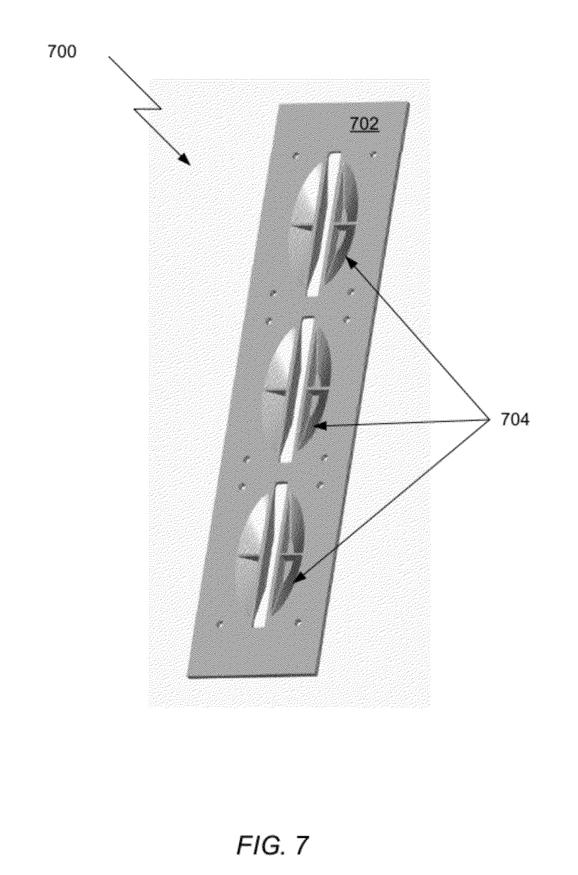

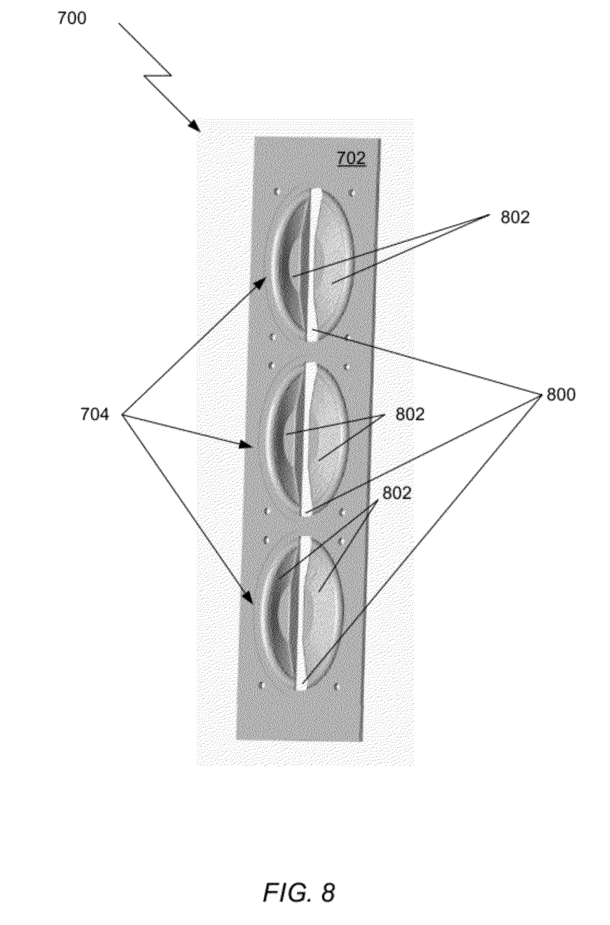

As an example, in FIG. 7, a front perspective view of an example of an implementation of an ALASW 700 is shown. The ALASW 700 may include a front plate 702 and a plurality of slotted waveguides 704. In FIG. 8, a back perspective view is shown of the example of an implementation of the ALASW 700 shown in FIG. 7. The ALASW 700 is shown with a front plate 702 and a plurality of slotted waveguides 704. The ALASW 700 also includes a plurality of slotted openings 800 and a plurality of volume displacement elements 802. As an example of operation, the ALALS operates in a way that emulates a continuous acoustic line source.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A slotted waveguide for use with an electrodynamic transducer having a transducer front surface for radiating acoustic energy from the electrodynamic transducer, wherein the transducer front surface is concave and wherein the electrodynamic transducer is operable to a desired high frequency, the slotted waveguide comprising:
a body with a slotted opening with a width not substantially greater than a wavelength corresponding to the desired high frequency cutoff; and
a volume displacement element having a displacement surface that extends inward into the electrodynamic transducer and complements in shape the transducer front surface.

2. The slotted waveguide of claim 1, wherein the electrodynamic transducer is a loudspeaker driver.

3. The slotted waveguide of claim 2, wherein the volume displacement element has a displacement surface that extends inward into the loudspeaker driver and complements in shape the driver front surface.

4. The slotted waveguide of claim 3, wherein the displacement surface is configured to be located approximately between 0.5 millimeters to 4 millimeters from the driver front surface.

5. The slotted waveguide of claim 3, wherein the loudspeaker driver is an elliptical driver, rectangular, racetrack-type, or conical.

6. The slotted waveguide of claim 5, wherein the elliptical driver is a speaker having dimension selected from the group consisting of four by six, six by nine, five by seven, and four by ten.

7. The slotted waveguide of claim 3, wherein the loudspeaker driver is a conical driver.

8. The slotted waveguide of claim 3, wherein the volume displacement element is constructed of material selected from the group consisting of thermoplastic resin, thermoset resin, wood, metal, and foamed polymer.

9. A loudspeaker system comprising:
a loudspeaker driver having a driver front surface for radiating acoustic energy from the loudspeaker driver, wherein the driver front surface is concave;
a slotted waveguide adjacent the driver front surface; and
a volume displacement element adjacent the driver front surface, wherein the volume displacement element is convex and is attached to the slotted waveguide.

10. The loudspeaker system of claim 9,
wherein the loudspeaker driver is operable to a desired high frequency, and
wherein the slotted waveguide includes a body having a slotted opening with a width not substantially greater than a wavelength corresponding to the desired high frequency.

11. The loudspeaker system of claim 10, wherein the volume displacement element has a displacement surface that extends inward into the loudspeaker driver and complements in shape the driver front surface.

12. The loudspeaker system of claim 11, wherein the displacement surface is located approximately 2 millimeters from the driver front surface.

13. The loudspeaker system of 11, wherein the loudspeaker driver is a conical driver.

14. The loudspeaker system of 11, wherein the loudspeaker driver is an elliptical driver.

15. The loudspeaker system of claim 14, wherein the elliptical driver is a speaker having dimension selected from the group consisting of four by six, six by nine, and four by ten.

16. The loudspeaker system of claim 11, wherein the volume displacement element is constructed of material selected from the group consisting of thermoplastic resin, thermoset resin, wood, metal, and foamed polymer.

17. An acoustic line array of slotted waveguides (“ALASW”) for use with a plurality of loudspeaker drivers, wherein each loudspeaker driver has a loudspeaker driver front surface for radiating acoustic energy from the loudspeaker driver, wherein the loudspeaker driver front surface is concave, and wherein the loudspeaker driver is operable to a desired high frequency, the ALASW comprising:
A plurality of body elements, wherein each body element includes a slotted opening with a width not substantially greater than a wavelength corresponding to the desired high frequency; and
a plurality of volume displacement elements, wherein each volume displacement element has a displacement surface that extends inward into the loudspeaker driver and complements in shape the loudspeaker driver front surface which corresponds to the volume displacement element.

18. The ALASW of claim 17, wherein each volume displacement element has a displacement surface that extends inward into the corresponding loudspeaker driver and complements in shape the driver front surface.

19. The ALASW of claim 18, wherein the displacement surface configured to be located approximately between 0.5 millimeters to 4 millimeters from the driver front surface.

20. The ALASW of claim 18, wherein the loudspeaker driver is an elliptical driver.

21. The ALASW of claim 20, wherein the elliptical driver is a speaker having dimension selected from the group consisting of four by six, six by nine, five by seven and four by ten.

22. The ALASW of claim 18, wherein the loudspeaker driver is a conical driver.

23. A line source loudspeaker comprising:
a plurality of loudspeaker drivers each having a driver front surface for radiating acoustic energy from each loudspeaker driver, wherein each driver front surface is concave;
a plurality of slotted waveguides adjacent to the plurality of loudspeaker drivers, wherein each individual slotted waveguide is adjacent to each individual driver front surface; and
a plurality of volume displacement elements, wherein each volume displacement element is adjacent each driver front surface, wherein each volume displacement element is convex and is attached to each slotted waveguide.

24. The line source loudspeaker of claim 23,
wherein each loudspeaker driver is operable to a desired high frequency, and
wherein each slotted waveguide includes a body having a slotted opening with a width not substantially greater than a wavelength corresponding to the desired high frequency.

25. The line source loudspeaker of claim 24, wherein each volume displacement element has a displacement surface that extends inward into each loudspeaker driver and complements in shape the driver front surface.

26. The line source loudspeaker of claim 25, wherein each displacement surface is located approximately between 0.5 millimeters to 4 millimeters from the driver front surface.

27. The line source loudspeaker of claim 25, wherein the loudspeaker driver is a conical driver.

28. The line source loudspeaker of claim 25, wherein the loudspeaker driver is an elliptical driver.

29. The line source loudspeaker of claim 28, wherein each elliptical driver is a speaker having dimension selected from the group consisting of four by six, six by nine, five by seven and four by ten.
